(19) United States
(12) Patent Application Publication
(10) Pub. No.: US 2023/0006281 A1
(43) Pub. Date: Jan. 5, 2023

(54) THERMAL MANAGEMENT SYSTEM FOR AN ELECTRIC COMPONENT

(71) Applicant: Valeo Systemes Thermiques, La Verriere (FR)

(72) Inventors: Rainer SONNENBERGER, La Verriere (FR); Roque SALAZAR-ALVEAR, La Verriere (FR); Richard COTTET, La Verriere (FR); Bastien JOVET, La Verriere (FR)

(73) Assignee: Valeo Systemes Thermiques, La Verriere (FR)

(21) Appl. No.: 17/778,181

(22) PCT Filed: Nov. 18, 2020
(86) PCT No.: PCT/FR2020/052121

§ 371 Date: May 19, 2022

(30) Foreign Application Priority Data
Nov. 20, 2019 (FR) FR1912981

(51) Int. Cl. H01M 10/6557; F28F 3/12; F28F 9/02; F28D 1/03; H01M 10/613; H01M 10/625

(52) U.S. Cl. CPC H01M 10/6557; F28F 3/12; F28F 9/0248; F28D 1/0316; H01M 10/613; H01M 10/625; F28F 2265/16; F28D 2021/008

(57) ABSTRACT

A thermal management system for an electric component has a housing for the electric component and a heat exchange plate extending over the surface of the lateral face of the housing. The plate has a fluid channel between a fluid inlet and a fluid outlet, a supply duct to supply the plate with fluid and a discharge duct, a casing defining the housing(s) and receiving the heat exchange plate and the supply and discharge ducts. The system includes a fluid collecting box arranged to collect fluid from a possible fluid leakage at the junction between the fluid inlet and the fluid outlet of the plate and the associated supply and discharge ducts, so as to prevent said leaked fluid from dripping into a bottom of the casing.

### CROSS-REFERENCE TO RELATED APPLICATIONS

This application is filed under 35 U.S.C. § 371 U.S. National Phase of International Application No. PCT/FR2020/052121 filed Nov. 18, 2020 (published as WO2021099739), which claims priority benefit to French application No. 1912981 filed on Nov. 20, 2019, the disclosures of which are herein incorporated by reference in their entirety.

### TECHNICAL FIELD

The electronic elements, such as electrical energy storage cells, integrated circuits, servers, data centers, etc. require thermal regulation in order to keep them within their operating temperature range.

In the automotive field for example, it is a known practice to use electric batteries in the form of electronic modules liable to release heat when operating. Each module can have a plurality of electronic cells received in a casing and liable to release heat when operating. High-density energy storage cells such as Li-ion batteries ideally need to operate in a temperature range of between 20° C. and 40° C., and a temperature that is too low has an impact on their power, while a temperature that is too high has an impact on their service life. It is therefore necessary to be able to thermally regulate them, whether this be in order to cool them or in order to heat them.

What is meant by unit cells is an individual electrochemical element equipped with a positive terminal and with a negative terminal.

What is meant by battery module is a collection comprising a plurality of unit cells contained in a casing, the cells being electrically connected to one another.

During the charging phase, the battery cells or module heat up according to the conditions of use and it is a known practice to regulate the temperature by plate heat exchangers in contact with the modules and in which canals for the circulation of a cooling liquid are formed.

### BACKGROUND OF THE INVENTION

With an aim to increase the surface area for heat exchange, document US2017176108 describes a heat exchanger for a battery which comprises first and second fluid transport panels, defining first and second flow canals, the first and second fluid transport panels being arranged such that they define an angle between them. The heat exchanger can also comprise a third fluid transport panel defining a third flow canal and arranged such that it defines an angle with respect to the second fluid transport panel. The heat exchanger comprises first and second plates which are connected in a fluidtight manner to one another along their peripheries and define a passage for the flow of fluid between their central fluid flow regions.

In general, in order to provide thermal management of battery cells of electric or hybrid vehicles, a heat-transfer liquid such as glycol water is often used. This liquid circulates through the plates or tubes in contact with the cells, and there is an exchange of heat between this heat-transfer liquid and the cells.

One risk associated with this technology is that if this liquid leaks into the battery pack, a lack of electrical isolation can occur, with consequences ranging as far as causing a fire to break out in the battery pack or even causing the cells in the pack to explode. In order to avoid this phenomenon, certain manufacturers make the choice of having no liquid connection within the battery pack and opt for a large plate at the bottom for example. However, certain battery pack architectures, and the increase in the surface areas for exchanges between the cells and the cooling exchangers give rise to increasing numbers of heat exchangers within the pack and therefore several connections between the piping supplying this liquid and the cooling exchangers.

The present invention seeks to prevent these risks.

The present invention notably seeks to prevent these risks associated with heat-transfer fluid leaking into the pack.

### BRIEF SUMMARY OF THE INVENTION

What is proposed is a thermal management system for an electrical component liable to release heat during its operation, in particular for an electrical energy storage module, this system comprising:
at least one housing intended to receive at least one electrical component, notably a plurality of such housings arranged in parallel;
at least one heat exchange plate extending over at least part of the surface of the lateral face of the housing, said at least one plate comprising at least one canal for heat-transfer fluid between a fluid inlet and a fluid outlet of said plate;
an intake duct configured to supply the plate with heat-transfer fluid via the fluid inlet of the plate and a discharge duct configured to remove the heat-transfer fluid from the plate via the fluid outlet of the plate;
a casing defining the housing or housings and receiving the heat-exchange plate and the intake and discharge ducts;
a fluid collecting tank arranged to collect any fluid that might leak from the junction between the fluid inlet and outlet of the plate and the associated intake and discharge ducts, so as to prevent this leaking fluid from dropping into the casing, notably into a region containing the at least one electrical component, notably into a bottom of the casing, notably into the region in which the battery cells are placed, notably into one or more of the housings.

Thanks to the invention, it is possible to ensure that even in the event of a leak at the junctions, or connections, between the fluid inlet and outlet of the plate and the associated intake and discharge ducts that might occur in the casing, notably the battery pack, the heat-transfer liquid or fluid does not come into contact with the battery cells, so that no defective isolation between the battery cells will be able to arise.

In other words, the invention proposes to avoid leaks of heat-transfer liquid thanks to the presence of a volume, by way of the collecting tank, around the connection regions so as to collect such liquid as might leak and thus prevent it from being able to create a short circuit within the battery pack.

According to one of the aspects of the invention, the system comprises a plurality of heat-exchange plates, notably arranged parallel to one another with, for each plate, junctions between the fluid intake and discharge ducts and the plate inlet and outlet, and the fluid collecting tank is common to all the plates so as to collect any fluid that might be leaking from all of the junctions associated with all of the plates.

According to one of the aspects of the invention, the collecting tank extends perpendicular to the heat-exchange plates, notably at one end thereof.

According to one of the aspects of the invention, each plate comprises a connecting part which comprises the fluid inlet and outlet, this connecting part extending over just part of one side of the associated plate.

According to one of the aspects of the invention, this connecting part takes the form of a lug projecting on one side of the plate, notably projecting on a side of the plate which is the width, and this connecting part is notably positioned in the upper part of the plate when the plate is in position in the system for normal use.

According to one of the aspects of the invention, the fluid collecting tank comprises notches for each receiving a connecting part of one of the plates.

According to one of the aspects of the invention, there is a sealing between the notch of the collecting tank and the connecting part of the plate.

According to one of the aspects of the invention, the notches have a rectilinear shape and are parallel.

According to one of the aspects of the invention, the notches extend over just part of the height of the collecting tank. In this way, the notches do not extend up to the bottom of the collecting tank.

In an alternative, the collecting tank is positioned along a lower edge of the connecting parts. Thus, the collecting tank is positioned below the connecting parts so that in normal operation this collecting tank can collect any leaking fluid that falls under gravity from the junctions of the ducts to the plates.

According to one of the aspects of the invention, the collecting tank extends from the connecting parts of the plate up to the foot of the heat-exchange plates. Thus, the collecting tank extends over the majority of the width of the heat-exchange plates. In this instance, the height of the collecting tank runs parallel to the width of the plates.

According to one of the aspects of the invention, the collecting tank has a bottom and lateral walls. In particular, the collecting tank is open at the top.

According to one of the aspects of the invention, certain walls of the collecting tank, notably all the lateral walls, are rectangular in shape.

According to one of the aspects of the invention, the collecting tank contains a plastics material and is notably formed as a single piece.

According to one of the aspects of the invention, the tank is fixed to the housing or housings, notably by bonding, screwing to the casing of the pack, or for example is held on the casing of the pack by a clip.

According to one of the aspects of the invention, the system comprises at least one sensor designed to detect presence of water in the collecting tank.

According to one of the aspects of the invention, this sensor is a water-level sensor positioned inside the collecting tank. Preferably, the collecting tank is of substantial length, two sensors being positioned one at each longitudinal end of this tank in order to detect a liquid leak whatever the inclination of the vehicle in the event of a leak.

As an alternative, the collecting tank common to all the heat-exchange plates can be replaced by a multitude of collecting tanks, for example each collecting tank being associated with one or two plates.

Thus, by virtue of the invention, it is possible to add on a volume for containing all of the plate connections so as to collect the heat-transfer liquid in the event of a leak. This liquid is therefore contained in this volume, which is separated and sealed from the other volume in which the battery cells are situated. The area around the joint between the cooling plates and the volume is sealed using for example a flexible lip or an added sealing compound such as a silicone seal for example.

It is moreover possible to position a sensor to detect the presence of the heat-transfer liquid in the heat-transfer liquid collecting volume so that information that there is a leak of heat-transfer liquid at one of the heat-exchanger connections, notably one of the plate connections, can be fed back for example to the vehicle on-board computer. This information can travel through a vehicle information network so as to display a visible indication warning that maintenance is required.

As an alternative, it is possible to add several level sensors, at least two, in order to evaluate the rate of leakage in the collecting tank so as to allow the vehicle to operate in a downgraded mode between initial detection of the leak and until such point as the fluid in the collecting tank reaches a maximum level beyond which the vehicle is to be made unsafe and can no longer be used.

According to one embodiment of the invention, said at least one plate forms a vertical contact surface for contact with a vertical heat-exchange surface of the electrical component that is to be cooled, when that component is placed inside the housing.

According to one embodiment of the invention in which the thermal management system comprises at least one plate positioned between two end plates, the main inlet of the intake duct is positioned on the fluid inlet of one of the end plates of the row and the main outlet is positioned on the outlet of the other end plate of the row.

The features set out in the paragraphs that follow can optionally be employed. They can be employed independently of one another or in combination with one another.

Said intake and discharge ducts can be parallel to one another and run transversely with respect to the canals over at least part of a transverse lateral face.

Said at least one plate can comprise a first series of fluid canals extending in a first plane and a second series of fluid canals extending in a second plane distinct from the first plane, each of the canals of the first series being in communication with a neighboring canal of the second series to form a plurality of U-shaped fluid paths.

Said at least one plate can comprise a border situated outside of a contact surface of said plate that contacts a vertical heat-exchange surface of the electrical component that is to be cooled, said border comprising a supply region and a discharge region, said supply and discharge regions having a substantially elongated shape which runs transversely with respect to the canals.

Said fluid inlet and the fluid outlet of said at least one plate can be positioned on the border of the plate.

According to one embodiment of the invention, the border of the plate has a substantially C-shaped profile so as to define a passage for a connecting duct, said connecting duct being intended to be connected to the main outlet of the discharge duct or to the main inlet of the intake duct so as to place the main inlet and the main outlet on the one same side so as to be connected to an external fluid circuit.

Thanks to the presence of the passage, it is thus possible to bring all of the connections of the thermal management system onto the same side so as to meet the connectivity constraints dictated by the external fluid circuit and also the packaging constraints so as to limit the volume occupied by the battery pack in the vehicle.

According to one embodiment of the invention, said at least one plate comprises a central sheet interposed between two lateral sheets, the central sheet being provided with grooves on each of the two faces, the three sheets being assembled with one another in order to form canals of the first series alternating with canals of the second series.

According to one particularly advantageous embodiment of the invention in which the system comprises at least one plate positioned between two end plates, said end plates each being equipped with a through-connection and with a connection that does not pass through, said connection that does not pass through having a bore section adjusted to reduce the flowrate of heat-transfer fluid in said end plates.

A through-connection is a connection which comprises two connection endpieces extending one on each side of the plate at the fluid inlet or the fluid outlet so as to allow fluid to pass through the plate and which is connected to a plate feed reservoir or to a plate discharge reservoir.

A connection that does not pass through is a connection which comprises a single connection endpiece which extends out from one face of the plate in order to allow fluid to pass between the plate feed reservoir and a supply duct, or the plate discharge reservoir and a discharge duct.

It is thus possible to increase the pressure drops at the end plates in order to adapt the flowrate of heat-transfer fluid according to the thermal power dissipated at these end plates. Specifically, the end plates of the row are in contact on just one side with an electrical component that is to be cooled. Thus, the end plates will exchange a thermal power that is a factor of two lower compared with the plates positioned in the center of the pack. By reducing the flowrate of the heat-transfer fluid in these end plates it is therefore possible to keep the temperature as uniform as possible across all the electrical components.

According to one embodiment of the invention, the connection that does not pass through comprises a fluidic connection endpiece extending from one face of said end plate and that is attached to said end plate at the fluid inlet or the fluid outlet, said fluidic connection endpiece having an inside diameter that is narrowed in comparison with a connection endpiece of a through connection so as to reduce the flowrate of the heat-transfer fluid in said end plate.

According to another embodiment of the invention, the connection that does not pass through has a deformation on one of the faces of the end plate that is the opposite to the face from which there extends a connection endpiece that forms the fluid inlet or fluid outlet of the connection that does not pass through, said depression being configured in such a way as to reduce the flowrate of the heat-transfer fluid in said end plate. Said depression can be a deformation only of the lateral sheet that does not bear the connection endpiece of the connection that does not pass through, or else of this same lateral sheet and of the intermediate sheet. Said depression can be formed for example by stamping.

According to one embodiment of the invention and in order to increase the surface areas for exchanges of heat with the electrical components, the thermal management system further comprises a plate comprising a plurality of heat-transfer fluid canals extending over at least part of the surface of the bottom face in order to form a contact surface contacting a horizontal heat-exchange surface of the electrical component that is to be cooled, when said component is in place in the housing.

In one embodiment of the invention, the intake duct and the discharge duct are formed of a plurality of pipes, the ends of each of the pipes being provided with a fluidic-connection endpiece configured to be connected to a fluidic connection endpiece of a through connection or of a connection that does not pass through belonging to a plate at the fluid inlet and the fluid outlet.

According to one aspect of the invention, the invention relates to a battery pack equipped with a thermal management system as defined hereinabove, said pack comprising at least one electrical energy storage module housed in the housing.

### BRIEF DESCRIPTION OF THE DRAWINGS

Other features, details and advantages of the invention will become apparent upon reading the detailed description below, and upon analyzing the appended drawings, in which:

FIG. 1 schematically depicts a perspective view of a battery pack equipped with a cooling device according to one embodiment of the invention;

FIG. 2 schematically depicts a perspective view of part of the cooling device of FIG. 1 without the electrical energy storage modules;

FIG. 3 schematically depicts the direction of circulation of the heat-transfer fluid in a plate of FIG. 2;

FIG. 4 schematically depicts an exploded view of a plate of heat-transfer fluid canals of FIG. 3;

FIG. 5 depicts an enlarged perspective view of a region of communication between the first series of canals and the second series of canals, viewed from the side of the first series of canals;

FIG. 6 depicts an enlarged perspective view of a region of communication between the first series of canals and the second series of canals, viewed from the side of the second series of canals;

FIG. 7 depicts an enlarged perspective view of a supply region of the canals of the plate;

FIG. 8 depicts an enlarged perspective view of a discharge region of the canals of the plate;

FIG. 9 depicts an enlarged view of the fluid inlet and outlet of a plate, the inlet and the outlet being equipped with tubular connection endpieces;

FIG. 10 depicts an enlarged view of a region of connection between two plates by pipes, one of the two plates being an end plate of a row;

FIG. 11 depicts another exemplary implementation of the invention;

FIG. 12 depicts a view of FIG. 11 with the collecting tank;

FIG. 13 depicts the collecting tank of the system of FIG. 12; and

FIG. 14 depicts another exemplary implementation of the invention.

### DETAILED DESCRIPTION OF THE INVENTION

The drawings and the description below contain, for the most part, elements of a certain character. Therefore, they not only can be used to better understand the present invention, but they also contribute to its definition, if applicable.

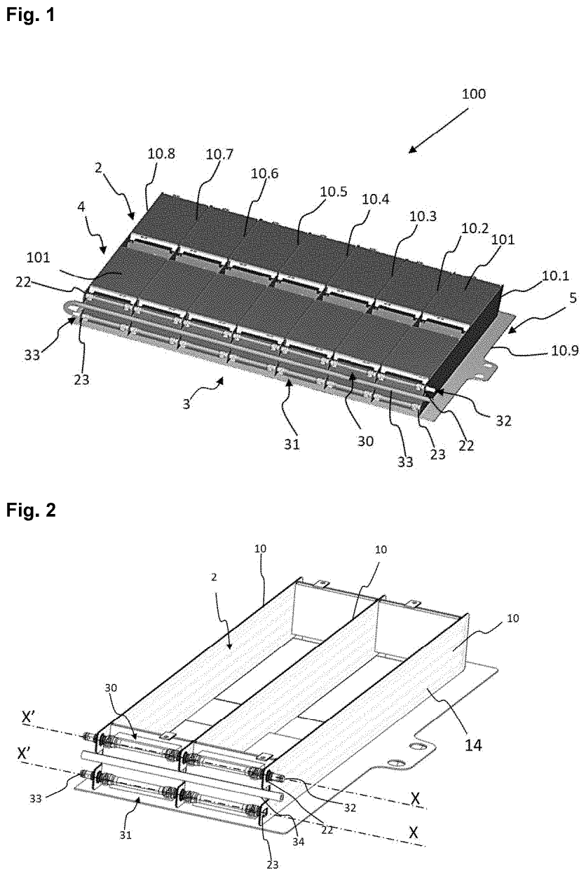

A first embodiment of a thermal management system for an electrical component 101 liable to release heat when operating is illustrated in FIG. 1 and FIG. 2.

An electrical component 101 is, for example, a rechargeable electrical energy storage device such as an electric battery or a battery module or an individual electrical cell.

FIG. 1 illustrates an example of an electrical component 101 in form of an electric module which has a substantially parallelepipedal shape comprising a base and lateral walls.

In FIG. 1, the modules are distributed in form of lines of modules, notably lines of two modules, to form a battery pack 100. Each module comprises a plurality of individual cells. Each cell is contained in a wrapper which is made of a thermally conducting material such as aluminum. Thus, each module comprises a horizontal heat-exchange surface and lateral heat-exchange surfaces. When the battery is operating, the cells heat up and it is therefore necessary to cool these cells or the module in order to keep the cells at an optimal operating temperature. Furthermore, it is appropriate to cool all of the cells uniformly.

According to the example illustrated in FIG. 1, the thermal management system comprises a plurality of housings 2 delimited by a bottom face 5, two longitudinal lateral faces 3 and a plurality of transverse lateral faces 4. Each housing 2 is configured to accept one or more electrical modules, in this instance arranged in a line of two modules.

Each module has a long side and a short side. Thus, in each line, the long sides of the aligned modules form two transverse lateral heat-exchange surfaces.

The thermal management system comprises a plurality of heat-exchange plates 10, each of the heat-exchange plates 10 extending over at least part of the transverse lateral surface to form a vertical surface for contact with the vertical heat-exchange surface formed by the long sides of a line of modules. The heat-exchange plate 10 comprises heat-transfer fluid canals 14 through which a heat-transfer fluid circulates in order to cool the line of modules through exchange of heat.

The heat-transfer fluid used is preferably glycol-water, with no limit on the glycol content (0% to 100%). Alternatively, the heat-transfer fluid can be chosen from among designated refrigerants.

In FIG. 1, the transverse lateral faces 4, the bottom 5 and the longitudinal lateral faces 3 form seven housings 2, each housing 2 being configured to receive a line of two modules. The thermal management system comprises eight heat-exchange plates 10 (here referenced to as 10.1, 10.2, 10.3, 10.4, 10.5, 10.6, 10.7, 10.8) arranged parallel to one another to form a row of heat-exchange plates 10. Thus, each transverse lateral face 4 of each line of modules is cooled by a heat-exchange plate 10. As can be seen in FIG. 1, the end heat-exchange plates 10 of the row or the peripheral heat-exchange plates 10 (here referenced to as 10.1, 10.8) are in contact with a transverse lateral face 4 of the line of modules.

Preferably, the heat-exchange plate 10 extends entirely over the transverse lateral face 4 of the line of modules.

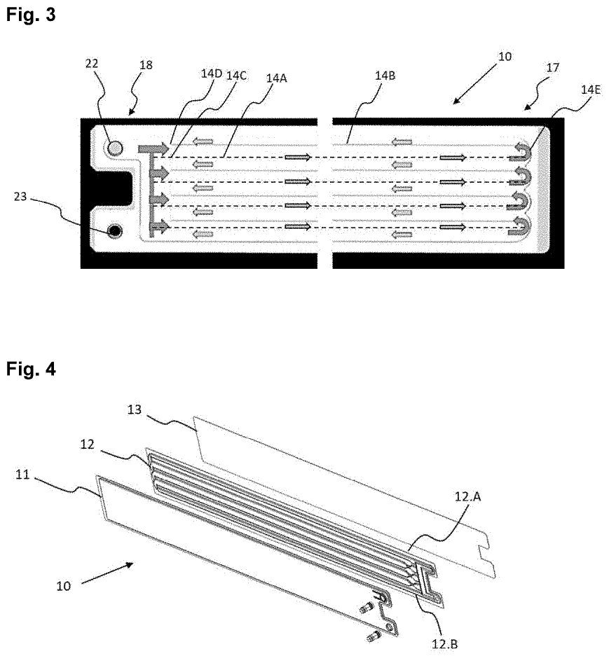

As can be seen in FIG. 3, the heat-exchange plate 10 comprises a plurality of heat-transfer fluid canals 14 intended to cool the modules. The heat-transfer fluid canals 14 are parallel to one another and extend over substantially the entire length of the heat-exchange plate 10.

A border of each heat-exchange plate 10 comprises a fluid inlet 22 and a fluid outlet 23.

Preferably, when all the heat-exchange plates 10 are aligned to form a row of heat-exchange plates 10, all the fluid inlets 22 and all the fluid outlets 23 are aligned along an axis X′X as illustrated in FIG. 2.

In order to ensure uniform cooling across all the modules or cells to reduce the temperature discrepancy between the cells, the heat-transfer fluid canals 14 are arranged in such a way that the direction in which fluid circulates alternates in a vertical direction between the fluid inlet 22 and the fluid outlet 23 of the heat-exchange plate 10.

The thermal management system comprises an intake duct 30 configured to supply each of the heat-exchange plates 10 with fluid in parallel, and a discharge duct 31 configured to jointly collect the fluid at the fluid outlet 23 of each of the heat-exchange plates 10.

The intake duct 30 is connected to the fluid inlets 22 of the heat-exchange plates 10 in order to supply the heat-exchange plates 10 in parallel, and the discharge duct 31 is connected to the fluid outlets 23 of the heat-exchange plates 10 in order to collect in parallel the fluid coming from the heat-exchange plates 10. Furthermore, the intake duct 30 and the discharge duct 31 respectively comprise a main inlet 32 and a main outlet 33 which are intended to be connected to a fluid circuit external to the cooling device.

In order to maintain an identical flowrate of the heat-transfer fluid through all the heat-exchange plates 10, the main inlet 32 and the main outlet 33 are positioned with respect to the fluid inlets 22 and the fluid outlets 23 of each of the heat-exchange plates 10 in such a way that the length of the path covered by the heat-transfer fluid from the main inlet 32 to the main outlet 33 is the same for each of the heat-exchange plates 10.

According to one embodiment of the invention and as illustrated in FIG. 1, the main inlet 32 is situated on one side of the battery pack 100 and the main outlet 33 on the opposite side of the battery pack 100.

In the example illustrated in FIG. 1, the main inlet 32 is situated on the fluid inlet 22 of the peripheral heat-exchange plate 10 (here referenced to as 10.1) and the outlet 33 is situated on the fluid outlet 23 of the peripheral heat-exchange plate 10 (here referenced to as 10.8). The length of the path covered by the fluid for each of the eight heat-exchange plates 10 is the same.

Preferably, the intake duct 30 and discharge duct 31 are parallel to one another and to axes X′X. They extend transversely with respect to the heat-transfer fluid canals 14 on the transverse lateral face 3.

Thus, the intake and outlet ducts 30, 31 and the end heat-exchange plates 10 at least partially form the perimeter of the battery pack 100.

The heat-exchange plate will now be described in detail with reference to FIG. 3 to FIG. 8.

As mentioned above, the heat-exchange plate 10 comprises heat-transfer fluid canals 14, which here include a first series of fluid intake canals 14A and a second series of fluid outlet canals 14B. The fluid intake canals 14A of the first series extend in a first plane and the fluid outlet canals 14B of the second series in a second plane. The two planes are distinct and are parallel to the transverse lateral face 4.

All the fluid intake and fluid outlet canals 14A, 14B are parallel to one another and extend over the entire length of the heat exchange plate 10. One end of each of the fluid intake canals 14A of the first series is in communication with the end of a neighboring fluid outlet canal 14B of the second series to form a plurality of U-shaped fluid paths.

Preferably, all canal communication regions 14E between the fluid intake and fluid outlet canals 14A, 14B are situated on the first side 17 of the heat-exchange plate 10. A first end 14C and a second end 14D of the U-shaped fluid path are situated on the second side 18 of the heat-exchange plate 10. The first end 14C and the second end 14D respectively form an inlet orifice for the fluid intake canal 14A, and an outlet orifice for the fluid outlet canal 14B.

The first end 14C of the U-shaped fluid path is in communication with an intake region 15 and the second end 14D is in communication with a discharge region 16. The intake region 15 and discharge region 16 have substantially elongate shapes and extend transversely with respect to the fluid intake and fluid outlet canals 14A, 14B. The intake and discharge regions 15, 16 are connected, respectively, to the fluid inlet 22 and fluid outlet 23.

Thus, and as can be seen in FIG. 3, the direction in which the fluid circulates in the heat-exchange plate 10 alternates in a vertical direction of the heat-exchange plate 10, in the heightwise sense of the heat-exchange plate 10. Specifically, when the heat-transfer fluid is circulating in the first series of fluid intake canals 14A, it becomes heated on contact with the heat-exchange surface of the modules. Thus, the fluid circulating in the second series of fluid outlet canals 14B is hotter than the fluid circulating in the first series of fluid intake canals 14A. In other words, circulation alternates between a cold canal and a hot canal in the heightwise direction of the heat-exchange plate 10. Because the module is formed of a plurality of cells positioned vertically, each cell, in terms of heat, experiences the cold canal and the hot canal of the heat-transfer fluid. Thus, the mean fluid temperature experienced by each cell is the same.

With reference to FIG. 4, the heat-exchange plate 10 is formed of a central sheet 12 interposed between two other lateral sheets 11, 13. The sheets 11, 12, 13 are produced as a single piece. They can be made of metal, notably of aluminum or of steel.

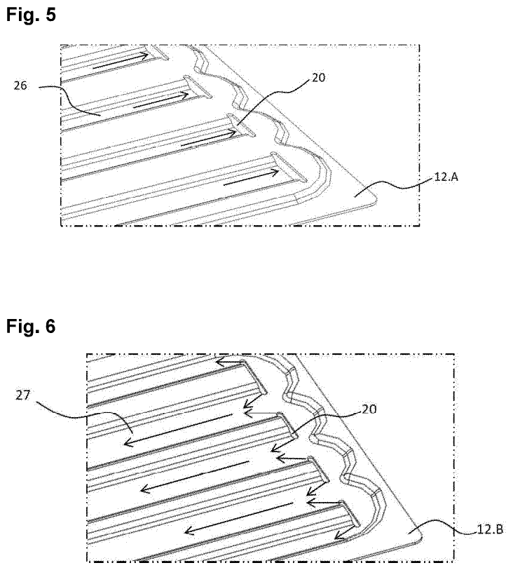

With reference to FIG. 5 and FIG. 6, the central sheet 12 comprises a first series of grooves 26 on first face 12.A to form the first series of fluid intake canals 14A, and a second series of grooves 27 on the second face 12.B to form the second series of fluid outlet canals 14B.

The central sheet 12 comprises openings 20 positioned at the ends of the grooves 26, 27 to create the canal communication region 14E between the fluid intake and fluid outlet canals 14A, 14B allowing the heat-transfer fluid to circulate from a fluid intake canal 14A of the first series to a fluid outlet canal 14B of the second series. The direction of circulation is shown by arrows in FIG. 5 and FIG. 6.

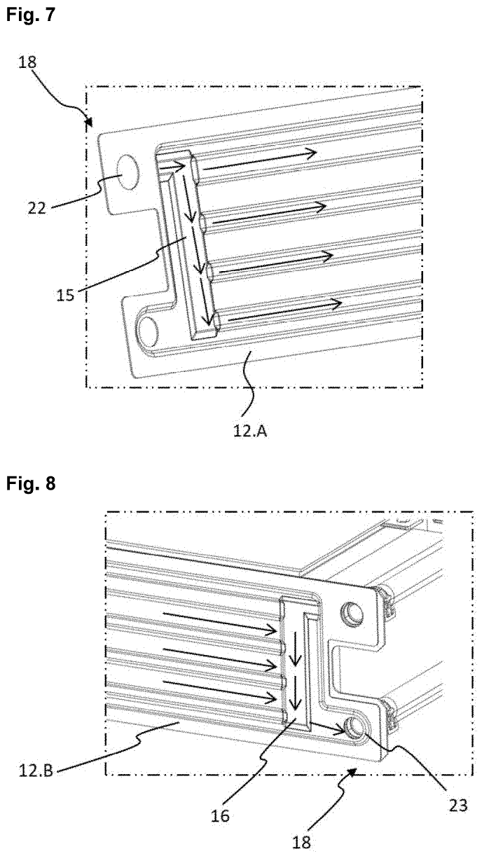

With reference to FIG. 7 and FIG. 8, the central sheet 12 comprises on the first face 12.A an intake region 15 in communication on the one hand with the inlet orifices of the fluid intake canals 14A and on the other hand with the fluid inlet 22. On the second face 12.B, the central sheet 12 comprises a discharge region 16 in communication on the one hand with the outlet orifices of the fluid intake canals 14B and on the other hand with the fluid outlet 23. The intake region 15 and the discharge region 16 are situated on the one same side 18 of the central sheet 12.

Preferably, the central sheet 12 is obtained as a single piece by stamping.

The three planar sheets 11, 12 and 13 have substantially the same dimensions and shapes. The lateral sheets 11, 13 are positioned one on each side of the central sheets 12 and close the grooves 26, 27 to form the fluid intake and fluid outlet canals 14A, 14B. The two sheets 11, 13 can be welded, bonded or assembled by brazing with the central sheet 12.

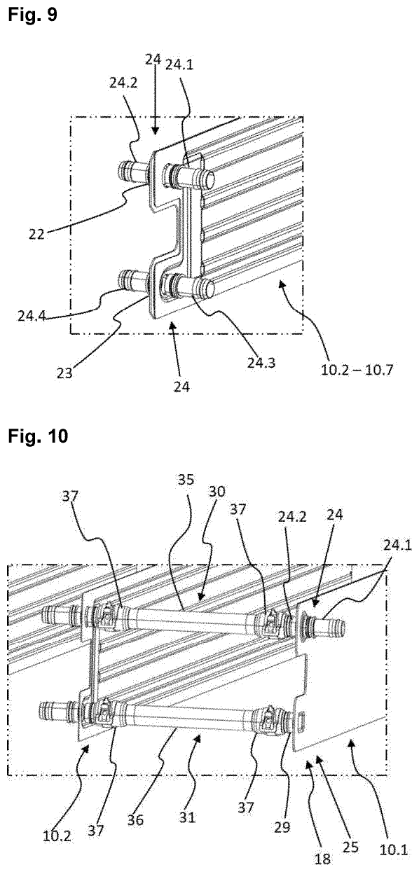

The connection of the intake region 15 and of the discharge region 16 of a heat-exchange plate 10 to the intake duct 30 and to the discharge duct 31 will now be described with reference to FIG. 9 and FIG. 10.

The intake duct 30 and the discharge duct 31 are formed from an assembly of a plurality of intake pipes 35 and discharge pipes 36. The ends of each intake pipe 35 and discharge pipe 36 are equipped with a tubular connection duct endpiece 37. As illustrated in FIG. 1 and FIG. 10, each of the intake pipes 35 and discharge pipes 36 is positioned between two heat-exchange plates 10. The tubular connection duct endpieces 37 are connected to the fluid inlets 22 and to the fluid outlets 23 of the two heat-exchange plates 10.

FIG. 9 illustrates a heat-exchange plate 10 intended to be positioned between two lines of modules, such as the heat-exchange plates 10 referenced to as 10.2 to 10.7 in FIG. 1. The heat-exchange plate 10 comprises a through-connection 24 at the fluid inlet 22 and a through-connection 24 at the fluid outlet 23.

At the fluid inlet 22, the through-connection 24 comprises three orifices produced respectively in the central sheet 12 (see FIG. 7 and FIG. 8) and in the lateral sheets 11, 13 at the border 18 and arranged facing one another, each of the orifices in the lateral sheets 11, 13 accepting an intake tubular connection endpiece 24.1, 24.2 which extends out from one face of the heat-exchange plate 10. One end of the intake tubular connection endpieces 24.1, 24.2 is connected to the connection endpieces 37 of an intake pipe 35 forming the intake duct 30. The two intake tubular connection endpieces 24.1, 24.2 thus form a fluidic passage between two intake pipes 35 of the intake duct 30 which are positioned one on each side of the heat-exchange plate 10 and also form a fluidic passage with the heat-exchange plate 10 feed reservoir 15.

Similarly, at the fluid outlet 23, the through-connection 24 comprises three orifices produced respectively in the central sheet 12 (see FIG. 7 and FIG. 8) and in the lateral sheets 11, 13 at the border 18 and arranged facing one another, each of the orifices accepting an outlet tubular connection endpiece 24.3, 24.4 which extends out from one face of the heat-exchange plate 10. One end of the outlet tubular connection endpieces 24.3, 24.4 is connected to the connection endpieces 37 of a pipe 36 forming the discharge duct 31, as illustrated in FIG. 10. The two outlet tubular connection endpieces 24.3, 24.4 thus form a fluidic passage between two pipes 36 of the discharge duct 31 which are positioned one on each side of the heat-exchange plate 10 and also form a fluidic passage with the plate discharge reservoir 16.

FIG. 10 illustrates a heat-exchange plate 10 positioned at the end of a row of heat-exchange plates 10, referenced to as 10.1 in FIG. 1, and a neighboring heat exchange plate 10 referenced to as 10.2. This end heat exchange plate 10 comprises a through-connection 24 and a connection 25 which does not pass all the way through. In the illustrated example of FIG. 10, the through-connection 24 forms the fluid inlet 22 of the end heat-exchange plate 10 and the connection 25 that does not pass all the way through forms the fluid outlet 23 of the end heat-exchange plate 10.

Similarly, the end heat exchange plate 10 referenced as 10.8 in FIG. 1 also comprises a through-connection 24 and a connection 25 that does not pass all the way through, the through-connection 24 forming the fluid outlet 23 of the end heat-exchange plate 10 and the connection 25 that does not pass all the way through forming the fluid inlet 22 of the end heat-exchange plate 10.

In the example illustrated in FIG. 10, the through-connection 24 of the end heat-exchange plate 10 referenced to as 10.1 comprises three orifices produced respectively in the central sheet 12 (see FIG. 7 and FIG. 8) and in the lateral sheets 11, 13 at the border 18 and arranged facing one another, each of the orifices in the lateral sheets 11, 13 accepting an intake tubular connection endpiece 24.1, 24.2 which extends out from one face of the end heat-exchange plate 10. One of the intake tubular connection endpieces 24.1 forms the main inlet 32 of the thermal management system and is connected to an external fluid circuit (not illustrated). The other connection endpiece 24.2 is connected to a connection endpiece 37 of an intake pipe 35 forming the intake duct 30 which is connected to the fluid inlet 22 of the next heat-exchange plate 10; in this instance in FIG. 10 this is the heat-exchange plate 10 referenced to as 10.2. The two connection endpieces 24.1, 24.2 thus form a fluidic passage connected to the feed reservoir 15 of the end heat-exchange plate 10.1.

The heat-exchange plates 10 positioned at the center of the battery pack are in contact with the modules positioned on each side of these heat-exchange plates 10. The end heat-exchange plates 10 are in contact only with the modules positioned on one side of these heat-exchange plates 10. Thus, the end heat-exchange plates 10 will exchange a thermal power that is a factor of two lower compared with the other heat-exchange plates 10. In order to ensure the most uniform possible temperature between the cells, it is appropriate for the modules in contact with the end heat-exchange plates 10 not to be cooled excessively. In order to do that, it is necessary to increase the pressure drops experienced by the fluid at these end heat-exchange plates 10 and thus reduce the flowrate of the heat-transfer fluid. More specifically, the flowrate of the heat-transfer fluid in the end heat-exchange plates 10 referenced to as 10.1, 10.8 needs to be halved.

To do that, the present invention proposes adjusting the bore section at the connection 25 that does not pass all the way through the end heat-exchange plate 10 in order to reduce the flowrate of the heat-transfer fluid. This connection 25 that does not pass all the way through is situated on the fluid outlet 23 of the end heat-exchange plate 10.1 or on the fluid inlet 22 of the end heat-exchange plates 10 references to as 10.8.

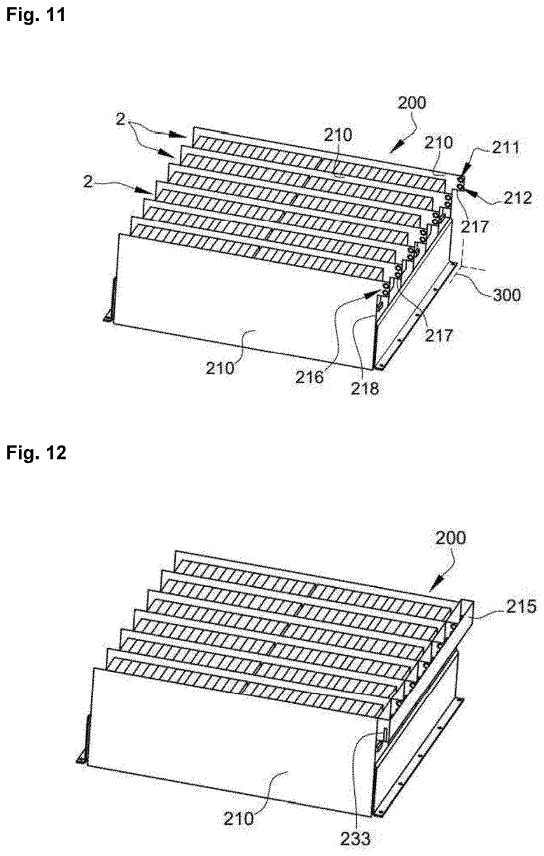

FIG. 11 shows another exemplary embodiment of the invention.

The thermal management system 200 of FIG. 11 comprises a plurality of housings 2 as described above, and heat-exchange plate 210 extending over the surface of the lateral face of each housing 2.

Each heat-exchange plate 210 comprises one or more heat-transfer fluid canals between a fluid inlet 211 and a fluid outlet 212 of said heat-exchange plate 210, like those described in the preceding examples.

An intake duct 30 configured to supply the heat-exchange plate 210 with heat-transfer fluid via the fluid inlet 211 of the heat-exchange plate 210 and a discharge duct 31 configured to discharge the heat-transfer fluid from the heat-exchange plate 210 via the fluid outlet 212 of the heat-exchange plate 210 are provided, in the manner of the preceding examples, and these are not depicted in FIG. 11.

A casing 300 defining the housings 2 and receiving the heat-exchange plates 210 and the intake and discharge ducts 30, 31 is provided. This casing 300 defines a pack.

As visible in FIG. 12, the system 200 comprises a fluid collecting tank 215 arranged to collect any fluid that might leak from the junction between the fluid inlet 211 and fluid outlet 212 of the heat-exchange plates 210 and the associated intake and discharge ducts 30 and 31, so as to prevent this leaking fluid from dropping into a bottom of the casing 300 that forms the battery pack.

The heat-exchange plates 210 are arranged parallel to one another with, for each heat-exchange plate 210, junctions between the fluid intake and discharge ducts 30 and 31 and the plate fluid inlet 211 and fluid outlet 212, and the fluid collecting tank 215 is common to all the heat-exchange plates 210 so as to collect any fluid that might be leaking from all of the junctions associated with all of the heat-exchange plates 210.

The connecting tank 215 extends perpendicular to the heat-exchange plates 210, notably at one end 216 thereof.

Each heat-exchange plate 210 comprises a connecting part 217 which comprises the fluid inlet 211 and the fluid outlet 212, this connecting part 217 extending over just part of one side of the associated heat-exchange plate 210.

This connecting part 217 takes the form of a lug projecting on one side 218 of the heat-exchange plate 210, projecting on a side of the heat-exchange plate 210 which is the width, and this connecting part 217 is positioned in the upper part of the heat-exchange plate 210 when the heat-exchange plate 210 is in position in the system for normal use.

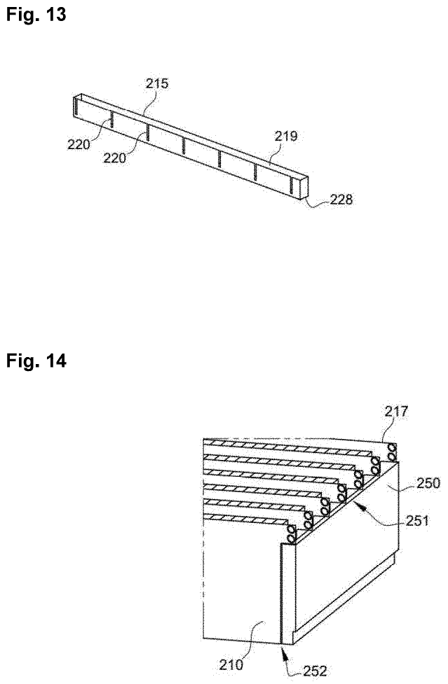

The fluid collecting tank 215 comprises notches 220, for receiving a connecting part 217 of one of the heat-exchange plates 210, as can be seen in FIG. 12 and FIG. 13.

There is sealing between the notch 220 of the collecting tank 215 and the connecting part 217 of the heat-exchange plate 210, for example in the form of a silicone seal.

The notches 220 have a rectilinear shape and are parallel.

The notches 220 extend over just part of the height of the collecting tank 215. In this way, the notches 220 do not extend up to the bottom of the collecting tank. The notches 220 are present only on a planar face of the tank 215.

The collecting tank 215 comprises a bottom 218 and lateral walls 219. The collecting tank 215 is open at the top.

All of the lateral walls 219 are rectangular in shape.

The collecting tank 215 contains a plastics material and is notably formed as a single piece.

The tank 215 is fixed to the housings 2, notably by bonding, screwing to the casing 300 of the pack, or else is held on the casing 300 of the pack by a clip for example.

The system 200 comprises at least one sensor 233 designed to detect the presence of water in the collecting tank 215.

This sensor 233 is a water-level sensor positioned inside the collecting tank 215. As a preference, if the collecting tank 215 is of substantial length, two sensors 233 will be positioned one at each longitudinal end of this tank 215 in order to detect a liquid leak whatever the inclination of the vehicle in the event of a leak.

As an alternative, the collecting tank 215 common to all the heat-exchange plates 210 can be replaced by a multitude of collecting tanks 215, for example each collecting tank 215 being associated with one or two heat-exchange plates 210.

As an alternative, it is possible to add several level sensors 233, at least two positioned along the vertical axis, in order to evaluate the rate of leakage in the collecting tank 215 so as to allow the vehicle to operate in a downgraded mode between initial detection of the leak and until such point as the fluid in the collecting tank 215 reaches a maximum level beyond which the vehicle is to be made safe and can no longer be used.

In an alternative illustrated in FIG. 14, an alternative collecting tank 250 is positioned along a lower edge 251 of the connecting parts. Thus, the alternative collecting tank 250 is positioned below the connecting parts 217 so that in normal operation this alternative collecting tank 250 can collect any leaking fluid that falls under gravity from the junctions of the ducts 30 and 31 to the heat-exchange plates 210.

The alternative collecting tank 250 extends from the connecting parts 217 of the heat-exchange plates 210 21 up to the foot 252 of the heat-exchange plates 210. Thus, the alternative collecting tank 250 extends over the majority of the width of the heat-exchange plates 210. In this instance, the height of the alternative collecting tank 250 runs parallel to the width of the heat-exchange plates 210.

What is claimed is:

1. A thermal management system for at least one electrical component, comprising:
at least one housing intended to receive the at least one electrical component;
at least one heat-exchange plate extending over at least part of a surface of a lateral face of the at least one housing, said at least one heat-exchange plate including a fluid inlet, a fluid outlet and at least one heat-transfer fluid canal for a heat-transfer fluid between the fluid inlet and the fluid outlet;
an intake duct configured to supply the heat-exchange plate with the heat-transfer fluid via the fluid inlet of the at least one heat-exchange plate and a discharge duct configured to remove the heat-transfer fluid from the at least one heat-exchange plate via the fluid outlet thereof;
a casing defining the at least one housing and receiving the at least one heat-exchange plate and the intake and discharge ducts;
a fluid collecting tank arranged to collect any fluid that might leak from junction between the fluid inlet and the fluid outlet of the at least one heat-exchange plate and the associated intake duct and discharge duct, so as to prevent this leaking fluid from dropping into the casing.

2. The system as claimed in claim 1, wherein the system includes a plurality of heat-exchange plates, with junctions between the intake duct, the discharge duct and the fluid inlet and the fluid outlet for each heat-exchange plate, and wherein the fluid collecting tank is common to all the heat-exchange plates so as to collect any fluid that might be leaking from all of the junctions associated with all of the heat-exchange plates.

3. The system as claimed in claim 2, wherein the collecting tank extends perpendicular to the heat-exchange plates.

4. The system as claimed in claim 1, wherein the at least one heat-exchange plate includes a connecting part which has the fluid inlet and the fluid outlet, the connecting part extending over just part of one side of the associated at least one heat-exchange plate.

5. The system as claimed in claim 4, wherein the fluid collecting tank comprises a notch receiving the connecting part of the at least one heat-exchange plate.

6. The system as claimed in claim 5, wherein there is sealing between the notch of the fluid collecting tank and the connecting part of the at least one heat-exchange plate.

7. The system as claimed in claim 1, wherein the collecting tank has a bottom and lateral walls.

8. The system as claimed in claim 1, wherein the collecting tank contains a plastics material and is formed as a single piece.

9. The system as claimed in claim 1, wherein the system includes at least one sensor designed to detect presence of water in the fluid collecting tank.

10. A battery pack including
a thermal management system for at least one electrical component, having:
at least one housing intended to receive the at least one electrical component;
at least one heat-exchange plate extending over at least part of a surface of a lateral face of the at least one housing, said at least one heat-exchange plate including a fluid inlet, a fluid outlet and at least one heat-transfer fluid canal for a heat-transfer fluid between the fluid inlet and the fluid outlet;
an intake duct configured to supply the heat-exchange plate with the heat-transfer fluid via the fluid inlet of the at least one heat-exchange plate and a discharge duct configured to remove the heat-transfer fluid from the at least one heat-exchange plate via the fluid outlet thereof;
a casing defining the at least one housing and receiving the at least one heat-exchange plate and the intake and discharge ducts;
a fluid collecting tank arranged to collect any fluid that might leak from a junction between the fluid inlet and the fluid outlet of the at least one heat-exchange plate and the associated intake duct and discharge duct, so as to prevent this leaking fluid from dropping into the casing;
said battery pack including the at least one electrical component in form of an electrical energy storage module received in the at least one housing.
